(19) United States
(12) Patent Application Publication
(10) Pub. No.: US 2008/0235700 A1
(43) Pub. Date: Sep. 25, 2008

(54) Hardware Monitor Managing Apparatus and Method of Executing Hardware Monitor Function

(75) Inventor: Akira Iguchi, Tokyo (JP)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 12/043,329

(22) Filed: Mar. 6, 2008

(30) Foreign Application Priority Data
Mar. 19, 2007 (JP) 2007-071357

(51) Int. Cl. G06F 9/30; G06F 9/50

(52) U.S. Cl. 718/104; 712/227; 712/E09.032

(57) ABSTRACT

A hypervisor OS includes a monitor context table in which plural monitor contexts each including monitor operation conditions and information concerning priority are set in order to set a hardware monitor function for monitoring operation states of plural physical processors that execute plural processes in parallel. The hypervisor OS causes the hardware monitor function to execute on a monitor context with high priority satisfying a monitor operation condition, for acquiring monitor data and outputting the monitor data together with timing data indicating time when the monitor operation condition is satisfied and outputs timing data indicating time when the monitor operation condition is satisfied, on a monitor context satisfying a monitor operation condition but having low priority.

### CROSS REFERENCE TO RELATED APPLICATION

This application is based upon and claims the benefit of priority from the prior Japanese Patent Application No. 2007-71357 filed on Mar. 19, 2007; the entire contents of which are incorporated herein by this reference.

### BACKGROUND OF THE INVENTION

1. Field of the Invention

The present invention relates to a hardware monitor managing apparatus and a method of executing a hardware monitor function, and, more particularly to a hardware monitor managing apparatus and a method of executing a hardware monitor function for monitoring an operation state of plural physical processors.

2. Description of the Related Art

In recent years, a multi-core processor in which plural processor cores are mounted on one chip has been developed. Products incorporating the multi-core processor have been placed on the market. The multi-core processor can realize performance far exceeding that of a single-core processor by effectively using the respective processor cores (hereinafter simply referred to as cores as well) and processor resources. However, in order to obtain the high performance, software needs to be tuned to sufficiently utilize functions of the multi-core processor.

A hardware monitor function of a processor is a function for, for example, observing and counting various state changes in the processor. By using this function, it is possible to perform, for example, tuning of software and measurement of performance of a system that are adjusted to characteristics of the processor. Basically, one hardware monitor function is provided for one processor.

A method of managing a hardware monitor function in a single-core processor in the past is briefly explained. First, in order to acquire performance information for each of processes, the hardware monitor function is set by designating a context of a process desired to be monitored, i.e., a monitor context. Specifically, designation of the monitor context is setting of a register in the processor. A normal hardware monitor function has a limit in resources such as the number of counters. Therefore, to acquire a large number of monitor data, it is necessary to change setting of the hardware monitor function and repeatedly execute a program. In order to solve the problem of the limitation on resources, data to be measured, i.e., monitor data are allowed to be discontinuous. There are methods of scheduling the monitor context in a time division manner. As a representative one of the methods, there is a multiplexing function of PAPI (Performance API). See, for example, a PAPI user guide (version 3.5.0) (PAPI USER'S GUIDE Version 3.5.0 (URL: http://icl.cs.utk.edu/papi/index.html).

However, these methods cannot be directly applied to the multi-core processor. This is because there is a problem of conflict among plural monitor contexts with respect to the hardware monitor function. In the multi-core processor, plural processes are simultaneously in an execution state on different cores. When the respective processes have monitor contexts in such an execution state, conflict concerning a right of use of the hardware monitor function occurs.

In order to solve this conflict, the monitoring contexts may be scheduled in a time division manner. However, in that case, acquired monitor data are discontinuous data. When accurate performance analysis is an object, it is a significant problem to decide how to interpret the acquired discontinuous data.

### SUMMARY OF THE INVENTION

A hardware monitor managing apparatus according to an aspect of the present invention includes: a monitor context table in which plural monitor contexts each including monitor operation conditions and information concerning priority are set in order to set a hardware monitor function for monitoring operation states of plural physical processors that execute plural processes in parallel; and a hardware-monitor managing unit that causes the hardware monitor function to execute on a monitor context for which the hardware monitor function determined on the basis of the priority is set, among one or more monitor contexts satisfying the monitor operation conditions, for acquiring monitor data and outputting the monitor data together with first time data indicating time when the monitor operation condition is satisfied, and outputs second time data, which indicates time when the monitor operation condition is satisfied, on a monitor context for which the hardware monitor function determined on the basis of the priority is not set, among the one or more monitor contexts satisfying the monitor operation conditions.

A method of executing a hardware monitor function according to another aspect of the present invention includes: providing a monitor context table in which plural monitor contexts each including monitor operation conditions and information concerning priority are set in order to set a hardware monitor function for monitoring operation states of plural physical processors that execute plural processes in parallel; causing the hardware monitor function to execute on a monitor context for which the hardware monitor function determined on the basis of the priority is set, among one or more monitor contexts satisfying the monitor operation conditions, for acquiring monitor data and outputting the monitor data together with first time data indicating time when the monitor operation condition is satisfied; and outputting second time data, which indicates time when the monitor operation condition is satisfied, on a monitor context for which the hardware monitor function determined on the basis of the priority is not set, among the one or more monitor contexts satisfying the monitor operation conditions.

### BRIEF DESCRIPTION OF THE DRAWINGS

FIG. 1 is block diagram showing the structure of a multi-core processor system having a hardware monitor function according to an embodiment of the present invention;

FIG. 2 is a diagram for explaining a relation between a hardware-monitor function unit and a host OS according to the embodiment of the present invention;

FIG. 3 is a diagram showing content of a monitor context to be set according to the embodiment of the present invention;

FIG. 4 is a diagram showing a format of monitor data stored in a buffer for a monitor context with highest priority according to the embodiment of the present invention;

FIG. 5 is a diagram showing a format of monitor data stored in a buffer for a monitor context with low priority according to the embodiment of the present invention;

FIG. 6 is a diagram showing the structure of a monitor context table according to the embodiment of the present invention;

FIG. 7 is a flowchart showing an example of a flow of processing of a logical core scheduler according to the embodiment of the present invention;

FIG. 8 is a diagram for explaining an example of states of physical cores during a system operation and an operation state of a hardware monitor function according to the embodiment of the present invention;

FIG. 9 is a diagram showing a simplified example of content of the monitor context table according to the embodiment of the present invention;

FIG. 10 is a diagram showing an example of content of a buffer for a monitor context A according to the embodiment of the present invention;

FIG. 11 is a diagram showing an example of content of a buffer for a monitor context B according to the embodiment of the present invention;

FIG. 12 is a block diagram showing the structure of a system according to a first modification of the embodiment of the present invention; and

FIG. 13 is a diagram for explaining a relation between a hardware monitor function unit having an automatic external output function and a host OS according to a second modification of the embodiment of the present invention.

### DETAILED DESCRIPTION OF THE PREFERRED EMBODIMENTS

Embodiments of the present invention will be hereinafter explained with reference to the accompanying drawings.

### First Embodiment

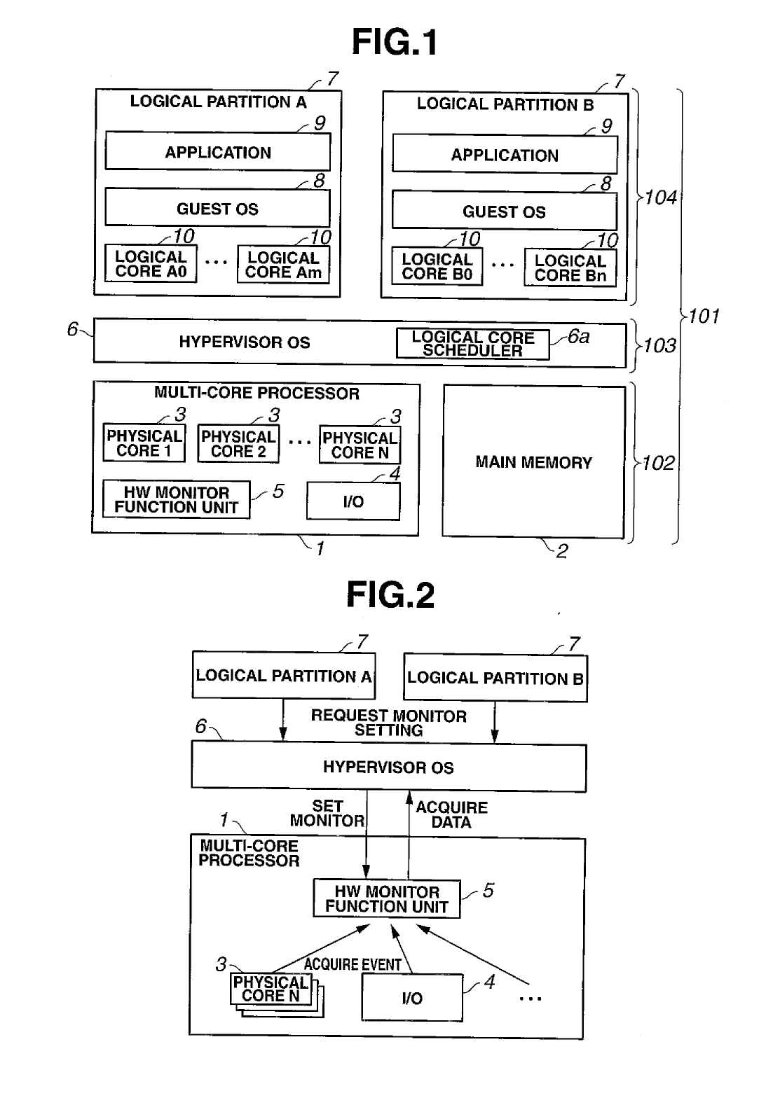

First, the structure of a system according to a first embodiment of the present invention is explained with reference to FIG. 1. FIG. 1 is a block diagram showing the structure of a multi-core processor system having a hardware monitor function according to the present embodiment.

In the present embodiment, a hypervisor operating system manages plural hardware monitor contexts set for plural logical partitions.

A multi-core processor system 101 is a computer system having so-called three layer structure and is, for example, a personal computer (PC). Among the three layers, a lowest layer 102 is a hardware layer including a processor 1 as a multi-core processor and a main memory 2. In general, various hardware devices are present in this layer 102. However, for simplification of explanation, the hardware devices are not shown in the figure. The processor 1 includes, together with plural physical core processors (hereinafter referred to as physical cores) 3, an input and output unit (hereinafter referred to as I/O unit) 4, and the like, a hardware monitor function unit (in FIG. 1, an HW monitor function unit) 5. There are N physical cores 3 (N is an integer equal to or larger than 2). The processor 1 can execute plural processes in parallel using the plural physical cores 3, which are physical processors, respectively. A function of the hardware monitor function unit 5 is described later. In the present embodiment, one hardware monitor function unit is provided in one processor (i.e., the processor 1). In an intermediate layer 103, a hypervisor operating system (hereinafter referred to as hypervisor OS) 6 is present. The hypervisor OS 6 is also called a virtual machine monitor (VMM). A function of the hypervisor OS 6 is to conceal physical hardware from guest operating systems (hereinafter referred to as guest OSs) on respective logical partitions of the highest layer 104 described later and provide virtual hardware. The hypervisor OS 6 manages states of the respective logical partitions as contexts. As advantages of using the hypervisor OS 6, for example, a) since plural guest OSs can be simultaneously run on a single system, it is possible to establish a system having all merits of the guest OSs, b) it is possible to conceal differences in the physical hardware, and c) operation errors of the guest OSs do not affect the entire system. The hypervisor OS 6 includes a logical core scheduler 6a as a scheduler unit.

In the highest layer 104, one or more logical partitions 7 are present. Guest OSs 8 and application programs (hereinafter simply referred to as applications) 9 operate in the respective logical partitions. In the present embodiment, there are two partitions A and B. Each of the logical partitions 7 has one or more logical core processors (hereinafter referred to as logical cores) 1O. In FIG. 1, in the logical partition A, as the logical cores 10, there are (m+1) (m is an integer larger than 0) logical cores A. In the logical partition B, as the logical cores 10 there are (n+1) (n is an integer larger than 0) logical cores B. The respective logical cores 10 are dispatched to the respective physical cores 3 by the logical core scheduler 6a of the hypervisor OS 6 whereby the guest OSs 8 and the programs or processes of the applications 9 in the respective partitions 7 can operate.

In other words, in the respective partitions 7, the plural logical cores 10 are recognized as the plural physical cores 3 with respect to the guest OSs 8. The hypervisor OS 6 manages contexts of the plural partitions 7, whereby the plural processes can operate on the processor 1.

A function of the hardware monitor function unit 5 is explained. FIG. 2 is a diagram for explaining a relation between the hardware monitor function unit 5 and a host OS. The hardware monitor function unit 5 is a resource of the processor 1. The hardware monitor function unit 5 acquires or counts events that occur in respective function units such as the physical cores 3, the I/O unit 4 that communicates with the outside of the processor 1, and memory management units (MMUs) in the physical cores. As the events, for example, there are a stall of an execution program, a cache miss, bus busy, and the like. When such events occur, for example, predetermined flags corresponding to the respective events are set and the number of times of the events is counted. Flag data and counted data can be acquired by accessing registers exclusively used for the data, respectively. Moreover, a function of causing interrupt because of an overflow of a counter may be implemented. In other words, the hardware monitor function unit 5 has a function of monitoring operation states of the various kinds of hardware in the processor 1.

The function of the hardware monitor function unit 5 is set by the hypervisor OS 6 serving as a hardware monitor management apparatus. Specifically, a user, who is a software developer or the like, sets the hardware monitor function using input devices such as a keyboard and a mouse while looking at a screen of a computer. Alternatively, the user sets the hardware monitor function by writing content of the setting in the execution program. The content set by the user is set in the hardware monitor function unit 5 in the processor 1 by the hypervisor OS 6. This is because the hardware monitor function unit 5 cannot be directly accessed from the programs on the respective logical partitions 7 and operation can be applied to the hardware monitor function unit 5 according to only a request to the hypervisor OS6.

In the present embodiment, there is only one hardware monitor function unit 5. The number of registers and the like monitored by the hardware monitor function unit 5 are limited. In other words, the numbers of resources of the hardware monitor function unit 5 are limited.

Moreover, since the physical hardware of the processor 1 is concealed by the hypervisor OS 6, it is necessary to appropriately respond to plural hardware monitor setting requests from the plural logical partitions 7. Specifically, for example, since content of setting for the hardware monitor function unit 5 from the partition A and content of setting for the hardware monitor function unit 5 from the partition B are different, it is necessary to appropriately respond to such different setting requests.

A normal hypervisor OS has only a normal function such as association (dispatch) of a logical core and a physical core. However, the hypervisor OS 6 according to the present embodiment has, in addition to the normal function of the hypervisor OS, a function of setting respective hardware monitor contexts and a function of operating the hardware monitor function unit 5 as functions of the hardware monitor managing apparatus. A hardware monitor context, i.e., a monitor context is setting information concerning a register related to a monitor request. The hardware monitor function unit 5 monitors data of the register in accordance with the setting information. The hypervisor OS 6 performs setting of the monitor context. Operation of the hardware monitor function unit 5 is performed at predetermined timing by the logical core scheduler 6a serving as a hardware monitor managing unit.

As described above, the hypervisor OS 6 performs operation (i.e., execution management) of the hardware monitor function unit 5 at predetermined timing determined by a predetermined schedule in accordance with the set plural monitor contexts. Therefore, the logical core scheduler 6a of the hypervisor OS 6 is a hardware monitor managing unit that, as described below, always monitors an operation state of the processor 1 and determines the monitor context of which monitor data is acquired in respective phases of the monitoring.

The processing is explained below.

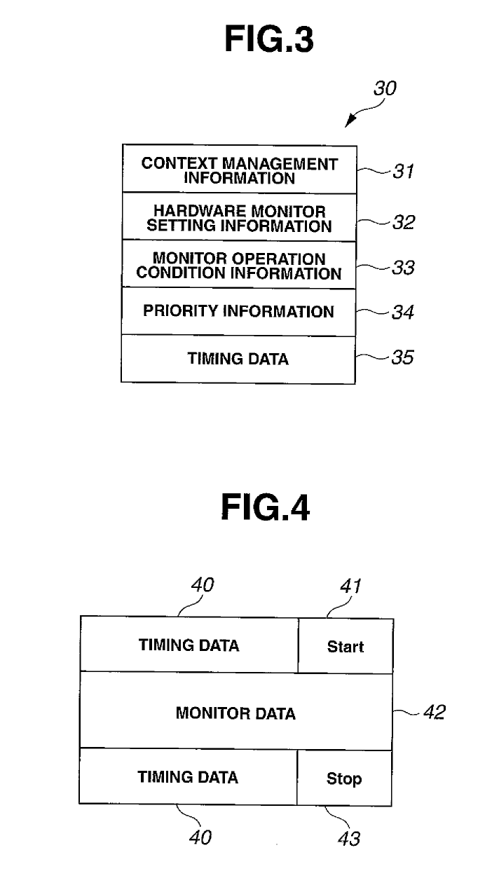

FIG. 3 is a diagram showing content of a monitor context to be set. Each of monitor contexts 30 roughly includes data of five items: context management information 31; hardware monitor setting information 32; monitor operation condition information 33; priority information 34; and timing data 35.

The context management information 31 includes an identifier of this monitor context, a valid and invalid flag indicating validity or invalidity, information concerning a buffer that stores monitor data, which is acquired data, and information concerning a logical partition for which setting of a monitor context is requested. The information concerning the buffer that stores monitor data is, for example, information indicating, for each of partitions, in which buffer area of the main memory 2 the monitor data is stored. The context management information 31 is mainly used for retrieval or deletion of a monitor context and notification of an event at the time of an overflow of the counter or at the time of an overflow of the data storage buffer.

The hardware monitor setting information 32 is information set in a register for controlling the hardware monitor function unit 5. As representative setting items of the hardware monitor setting information 32 are items such as a type of an event to be acquired and a behavior of the counter. In original setting of a hardware register, it is necessary to designate a physical value, for example, a physical core number. For a logical partition, a logical value, for example, a logical core number is designated. Therefore, in the present embodiment, it is permitted to set a logical value for the logical partition. When the hypervisor OS 6 executes the logical partition, the hypervisor OS 6 converts the logical value into an appropriate physical value.

The monitor operation condition information 33 is information concerning a setting item for setting conditions for acquiring monitor data. The information is expresses the condition that the hardware monitor function unit 5 is effective by a logical arithmetic expression (here, at least one of a logical product (AND) and a logical sum (OR)) concerning execution states of respective logical cores.

When a logical core is in an execution state, the logical core is allocated to a physical core. Therefore, an execution state of each of plural logical cores is represented by a logical arithmetic expression.

As a new request for the hardware monitor function of the multi-core processor, performance measurement in various units or ranges is conceivable. In general, information obtained by using the hardware monitor function is information concerning the entire processor. Therefore, there is a request for acquiring monitor data as such information concerning the entire processor. However, on the other hand, there is also a user who develops a software program in process units or core units in which processes operate. It is also possible that such a user requests to acquire, for example, monitor data during operation of a specific core, monitor data concerning a combination of plural cores, and the like.

According to the present embodiment, it is possible to acquire monitor data corresponding to various requests by using a logical arithmetic expression in the monitor operation condition information 33 of the monitor contexts 30.

For example, the user can set the monitor operation condition information 32 to acquire only monitor data directly related to an operation of a specific logical core or a specific process.

By designating execution states of all logical cores belonging to a specific logical partition using a logical arithmetic expression combined by a logical sum (OR), the user can set the monitor operation condition information 33 to acquire only monitor data related to the specific logical partition. As a result, it is possible to perform performance evaluation in logical partition units.

Moreover, it is also possible to prepare a special value with which a condition is always satisfied. For example, by setting a value such as “1” for a predetermined register in order to acquire data of all monitor contexts, the user can also set the predetermined register to acquire all monitor data. As described above, according to such monitor operation condition information, it is possible to acquire monitor data corresponding to a performance measurement request in various units or ranges.

In the present embodiment, only AND and OR are used in the logical expression in order to simplify processing for setting a condition and processing for checking the condition. By using a simple logical expression, an interface for setting a condition in the hypervisor OS 6 is simplified and it is possible to increase speed of checking the set condition. It is also possible to use a more complicated logical expression. However, if a complicated logical expression is used, an overhead of the processing for checking a condition increases. In the present embodiment, since condition check is performed every time when a logical core is switched, considering that this overhead cannot be allowed, the complicated logical expression is not used.

In other words, by using an AND condition, an OR condition, or a special condition always satisfied as a monitor operation condition, it is possible to simply describe various conditions. Moreover, by giving a combination of logical cores concerning a process group of interest to a monitor context as a monitor operation condition, it is possible to acquire performance information in logical core units, performance information of the plural logical cores, or performance information of the entire system. In other words, it is possible to acquire performance information in various units or ranges.

In the past, a person who develops software slices information during a specific core operation from information concerning an entire processor by directly looking at acquired monitor data. Therefore, the slicing is often difficult. By setting the monitor operation conditions described above, even when the multi-core processor is operating in a multi-OS, it is possible to execute the hardware monitor function in various units or ranges.

The priority information 34 is information concerning priority for monitor contexts for solving conflict of usage of the function of hardware monitor function unit 5 caused when the monitor operation conditions are simultaneously satisfied among the plural monitor contexts. When such conflict occurs, a monitor context with highest priority is set valid and data of the monitor context with highest priority is monitored by the hardware monitor function unit 5. Therefore, higher priority is set for an important monitor context and continuous monitor data can be acquired for the monitor context with highest priority. The user sets information concerning priority according to purposes.

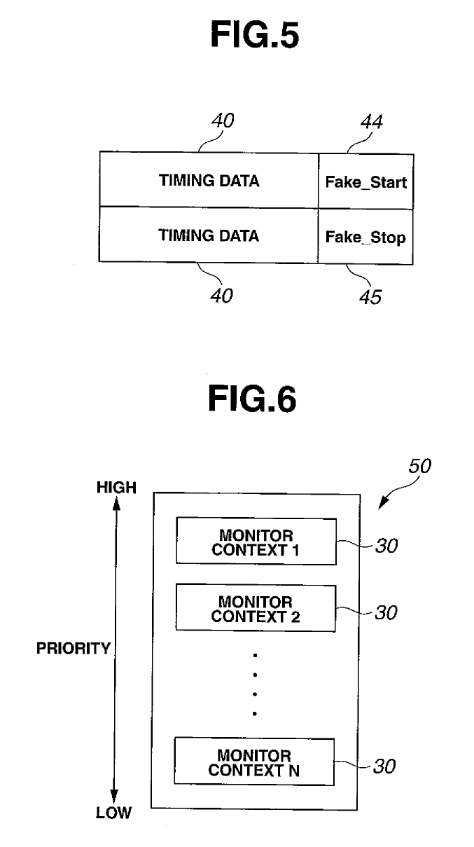

Timing data 35 is time data recorded when the monitor operation conditions are satisfied and dissatisfied. The timing data 35 is used for supporting judgment on reliability of acquired monitor data. By using the time data, the acquired monitor data can be finally obtained in a format shown in FIG. 4 or FIG. 5. Therefore, depending on priority of a monitor context data, monitor data is recorded in one of two types of formats according to priority of the monitor context at the time when the monitor operation conditions are satisfied and dissatisfied.

FIG. 4 is a diagram showing a format of monitor data stored in the buffer concerning a monitor context with highest priority when the monitor operation conditions are simultaneously satisfied in a certain phase among the plural monitor contexts. FIG. 5 is a diagram showing a format of monitor data stored in the buffer concerning a monitor context with low priority when the monitor operation conditions are simultaneously satisfied in a certain phase among the plural monitor contexts.

Concerning the monitor context with highest priority among the plural monitor contexts, as shown in FIG. 4, timing data 40 and a Start flag 41 at a point when the monitor operation condition are satisfied anew are recorded to indicate that use of the function of the hardware monitor function unit 5 is started. Thereafter, at a point when the monitor operation condition is dissatisfied, the monitor data 42, the timing data 40 at that point, and a Stop flag 43 are recorded to indicate that use of the function of the hardware monitor function unit 5 is finished.

Concerning a monitor context that is not the monitor context with highest priority, as shown in FIG. 5, at a point when the monitor operation condition is satisfied anew or at a point when a right of use of the hardware monitor function is deprived by another monitor context with highest priority, the timing data 40 and the Fake_Start flag 44 at that point are recorded to indicate that discontinuous data starts. Thereafter, at a point when the monitor operation condition is dissatisfied or at a point when a right of use of the function of the hardware monitor function unit 5 is acquired, the timing data 40 and the Fake_Stop flag 45 at that point are recorded to indicate that the discontinuous data ends. Therefore, among the one or more monitor contexts satisfying the monitor operation conditions, concerning a monitor context for which the hardware monitor function determined on the basis of the priority information is not set, time data indicating time when the monitor operation condition is satisfied is outputted and recorded together with the Fake_Start flag 44 and the Fake_Stop flag 45.

As the timing data 40, appropriate time data corresponding to a system in which the hardware monitor function is implemented such as a value of a real time clock is used. The Start flag 41 and the Stop flag 43 are always recorded in pair. The Fake_Start flag 44 and the Fake_Stop flag 45 are always recorded in pair.

In this way, the timing data 40 as time data and the monitor operation state data (the Start and Stop flags 41 and 43 and the Fake_Start and Fake_Stop flags 44 and 45) are outputted and recorded together with the monitor data 42. By using these recorded data, to cope with the problem in that monitor data concerning a context with low priority is discontinuous in the recorded data, it is possible to calculate coverage indicating how much percentage of data originally desired to be acquired the acquired data corresponds to. In other words, these recorded data can be used as data for judging reliability of the monitor data.

Therefore, when the monitor operation condition is satisfied for only one monitor context among the plural monitor contexts, only one monitor data of the monitor context is recorded. However, when the monitor operation conditions are simultaneously satisfied among the plural monitor contexts, monitor data of a monitor context with highest priority is recorded in the format shown in FIG. 4. In that case, monitor data of the other monitor contexts with low priority are not acquired. However, as shown in FIG. 5, timing data at a point when the monitor operation conditions are satisfied and timing data at a point when the monitor operation conditions are dissatisfied or at a point when there is no other monitor context with high priority and a right of use of the function of the hardware monitor function unit 5 is acquired are outputted to the buffers together with predetermined indexes (here, both the flags of Fake_Start and Fake_Stop) and recorded therein, respectively.

Therefore, the user can grasp a point when the respective monitor contexts have become discontinuous and the number of times or an amount of discontinuous data by looking at the data concerning the monitor contexts recorded as described above.

The monitor contexts 30 described above are managed in order of priority in a table shown in FIG. 6. FIG. 6 is a diagram showing the structure of a monitor context table. As shown in FIG. 6, the plural monitor contexts 30 are recorded in order of priority in a monitor context table 50. The plural monitor contexts 30 are managed in order of priority for the purpose of minimizing an overhead involved in processing for checking the monitor operation conditions at the time of logical core switching (at the switching time of dispatch of physical core). In the present embodiment, the logical core scheduler 6a has the monitor context table 50.

The hypervisor OS 6, more specifically, the core scheduler 6a of the hypervisor OS 6 scans contents of all the monitor contexts 30 of the monitor context table 50 in order from one with highest priority to thereby check whether the monitor operation conditions described in the monitor operation condition information 33 are satisfied for the respective monitor contexts 30. Concerning a monitor context with highest priority among monitor contexts for which the monitor operation conditions are satisfied as a result of the scanning, the monitor data 42 is recorded in the format shown in FIG. 4. Concerning a monitor context with priority lower than that of the monitor context with highest priority indicated by the priority information 34 among the plural monitor contexts for which the monitor operation conditions are satisfied, data is recorded in a format shown in FIG. 5.

In the present embodiment, basically, it is necessary to scan all table entries (i.e., all the monitor contexts) in order to acquire timing data of all the monitor contexts. However, when timing data is not necessary for all of the monitor contexts, the scanning may be finished at a point when the monitor operation conditions are satisfied for only one or more entries with high priority.

When the monitor context is registered, a request for setting the monitor context 30 for the respective logical partitions 7 is issued. The hypervisor OS 6 registers the monitor contexts as an appropriate table entry in the monitor context table 50 in accordance with priority of the monitor context 30. The plural monitor contexts 30 can be registered for each of the logical partitions 7. However, when the number of monitor contexts increases, a processing load in the logical core scheduler 6a increases. Therefore, a maximum number of contexts that can be registered in the monitor context table 50 may be limited taking into account an allowable amount of overhead.

When the monitor context 30 is deleted, user designates an identifier of the monitor context 30 for the logical partition 7 corresponding thereto to thereby delete a table entry coinciding with the identifier.

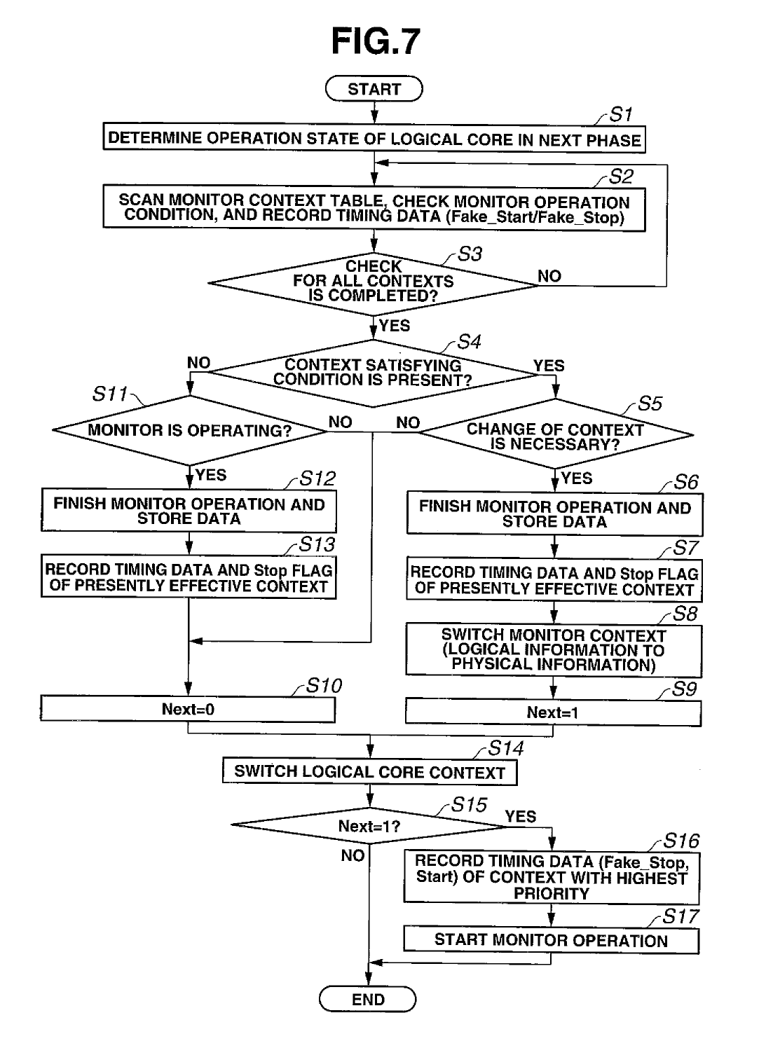

Processing of a logical core scheduler added with the function of the hardware monitor function unit 5 is explained. FIG. 7 is a flowchart showing an example of processing of the logical core scheduler. The logical core scheduler as a hardware monitor managing unit is always executed. Every time the logical core scheduler is executed, i.e., in each of phases of the execution, the logical core scheduler executes processing shown in FIG. 7.

First, like the normal logical core scheduler, the logical core scheduler 6a determines an operation state of a logical core in the next phase (step S1). In other words, a logical core that operates in the next phase is determined.

Next, the logical core scheduler 6a scans all the monitor contexts 30 of the monitor context table 50 shown in FIG. 6 in order of priority and checks respective monitor operation conditions (step S2). Among the monitor contexts 30 for which the monitor operation conditions are satisfied, concerning the monitor context 30 that is not a monitor context with highest priority and in which the Fake_Start flag 44 is not recorded up to the present phase, the logical core scheduler 6a outputs the timing data 40 and the Fake_Start flag 44 and records the same in the buffers corresponding thereto. Among the monitor contexts 30 for which the monitor operation conditions are not satisfied, concerning the monitor contexts 30 in which the Fake_Stop flag is not recorded yet after the recording of the Fake_Start flag 44, the logical core scheduler 6a outputs the timing data 40 and the Fake_Stop flag 45 and records the same in the buffers corresponding thereto.

It is judged whether the checking processing in step S2 has been finished for all the monitor contexts 30 (step S3). When the checking processing has not been finished for all the monitor contexts, a result in step S3 is NO and the processing returns to step S2. When the checking processing in step S2 is finished for all the monitor contexts 30, a result in step S3 is YES and the logical core scheduler 6a judges whether there is the monitor context 30 for which the monitor operation condition is satisfied (step S4).

It is assumed that one or more monitor contexts 30 satisfying the respective monitor operation conditions are detected in the scanning processing in step S2. In that case, a result in step S4 is YES. The logical core scheduler 6a checks whether the monitor context 30 with highest priority among the monitor contexts 30 for which the monitor operation conditions are satisfied coincides with a presently valid context (a monitor context as a monitor context with highest priority that presently uses the function of the hardware monitor function unit 5). The logical core scheduler 6a checks whether it is necessary to change the monitor contexts (step S5).

When it is necessary to change the monitor contexts, a result in step S5 is YES. The logical core scheduler 6a finishes a monitor operation and stores the present monitor data 42 in the buffer corresponding thereto (step S6). After storing the monitor data 42, the logical core scheduler 6a records the timing data 40 and the Stop flag 43 (step 87).

After storing the data, the logical core scheduler 6a switches the monitor context 30 for which monitor data is acquired (step S8). At this point, the logical core scheduler 6a converts logical information (a logical core number, etc.) of the monitor context 30 into physical information (a physical core number, etc.) and, then, sets the hardware monitor function. Thereafter, the logical core scheduler 6a sets a Next flag to 1 (step S9). The processing in step S9 is performed for the purpose of starting a monitor operation before entering the next phase. When it is unnecessary to change the monitor context 30, a result in step S5 is NO and a monitor operation is already continuously performed for the monitor context 30 not changed. Therefore, the logical core scheduler 6a sets the Next flag to 0 (step S10).

On the other hand, when the monitor context 30 satisfying the monitor operation condition is not found in the scanning processing in step S2, it is necessary to stop the monitor operation. Therefore, in that case, a result in step S4 is NO. The logical core scheduler 6a checks a state of the present monitor operation and checks whether the monitor operation is performed (step S11).

When the monitor is operating, the logical core scheduler 6a finishes the monitor operation and stores monitor data in the buffer corresponding thereto (step S12). After storing the monitor data, the logical core scheduler 6a records the timing data 40 and the Stop flag 43 (step S13). Processing in steps S12 and S13 is the same as the processing in steps S6 and S7. When the monitor operation is stopped, a result in step 11 is NO and the processing in steps S12 and S13 is not performed. The processing shifts to step S10 and the Next flag is set to 0.

Thereafter, the logical core scheduler 6a switches the logical core context in the same manner as the normal logical core scheduler (step S14). Finally, the logical core scheduler 6a checks whether the Next flag is 1 (step S15). When the Next flag is 1, a result in step S15 is YES. The logical core scheduler 6a records the timing data 40 and the Start flag 41 of the monitor context 30 that becomes valid in the next phase (step S16). When the Fake_Start flag 44 is recorded up to the present phase, the Fake_Stop flag 45 is recorded before the Start flag 41. The logical core scheduler 6a starts the monitor operation in order to acquire monitor data from the hardware function unit 5 (step S17).

In FIG. 7, in steps S6 and S12, the monitor operation is finished. In other words, the monitor operation is allowed during processing of the logical core scheduler 6a. However, depending on a purpose of performance measurement, there could be a request for not acquiring monitor data affected by the processing of the monitor contexts 30. Therefore, in such a case, in stead of finishing the monitor operation in steps S6 and S12, processing for judging whether the monitor operation is being performed is provided before step S1 and, when the monitor operation is being performed as a result of the judgment, processing for finishing the monitor operation is provided. Moreover, when the monitor context 30 for which the monitor operation condition is satisfied is detected in step S4, the logical core scheduler 6a always sets the Next flag to 1 and starts the monitor operation at the end of the processing shown in FIG. 7.

In this way, the monitor operation is finished and started in the beginning and the end of the processing of the logical core scheduler 6a shown in FIG. 7. Consequently, it is possible to prevent monitor data affected by the processing for the monitor contexts 30 from being acquired.

The structure and the main components of the system according to the present embodiment have been explained.

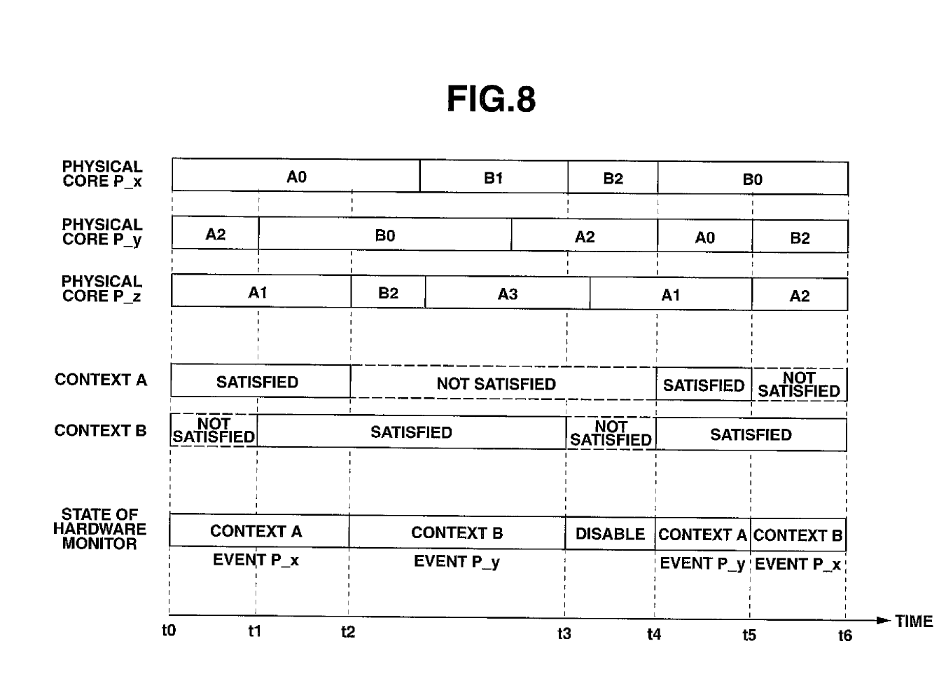

An example of a situation during a system operation is described and it is explained how the functions described above operate. FIG. 8 is a diagram for explaining an example of states of physical cores during a system operation and an operation state of the hardware monitor function. For simplification of explanation, the processor 1 has three physical cores P_x, P_y, and P_z, two logical partitions A and B are present in a higher layer, and each of the logical partitions A and B has logical cores A, . . . , Am and B0, . . . , Bn. As monitor contexts, monitor contexts A and B are set for each of the logical partitions A and B.

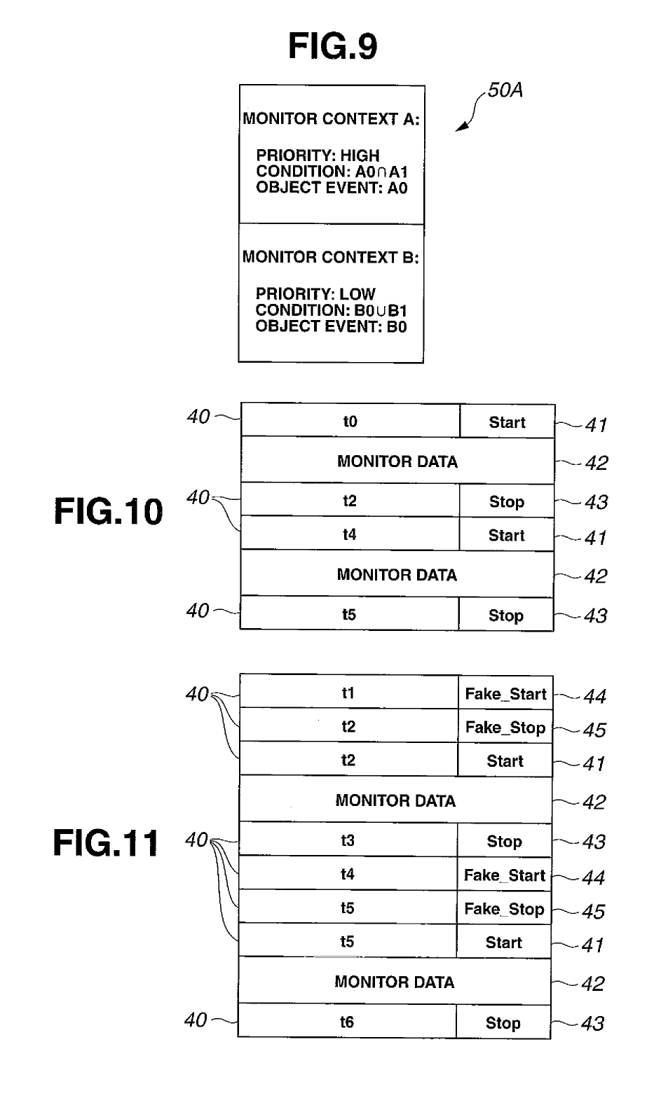

FIG. 9 is a diagram showing a simplified example of content of a monitor context table. It is assumed that monitor contexts shown in FIG. 9 are set in a monitor context table 50A. As shown in FIG. 9, the monitor context A has priority set higher than that of the context B. Moreover, in the monitor context A, a monitor operation condition is that the logical cores A0 and A1 are simultaneously executed. In the monitor context B, a monitor operation condition is that the logical core B0 or B1 is executed. Data of an object event is data of the logical core A0 in the monitor context A and is data of the logical core B0 in the monitor context B.

A result obtained by the logical core scheduler 6a on the hypervisor OS 6 by performing the processing according to the processing procedure shown in FIG. 7 on the basis of the logical cores and the monitor contexts is shown in FIG. 8.

In FIG. 8, dispatch states of logical cores with respect to three physical cores P_x, P_y, and P_z are shown in an upper column. In a middle column in FIG. 8, satisfaction and dissatisfaction of monitor operation conditions are shown for the monitor contexts A and B with respect to combinations of the logical cores at respective points in time. Depending on a combination of the logical cores, as shown in FIG. 8, conditions may be simultaneously satisfied in plural monitor contexts. In that case, as shown in FIG. 8, a monitor context to be valid next is determined according to priority of the monitor contexts. In FIG. 8, since priority of the context A is higher than that of the context B, the context A is selected in two places where the conditions are simultaneously satisfied.

Correspondence between logical core numbers and physical core numbers is dynamically determined during a system operation. Therefore, in the monitor contexts, an object event is set by using a logical core number and the logical core scheduler 6a dynamically converts the logical core number event into a physical core number. Under “state of hardware monitor” in FIG. 8, a state in which object events are changed in accordance with correspondence between logical cores and physical cores during execution is shown.

This is explained more specifically. It is assumed that the three physical cores P_x, P_y, and P_z operate as shown in FIG. 8. At time t0 to t1, the monitor operation condition for the monitor context A is satisfied and the monitor operation condition for the monitor context B is dissatisfied. Therefore, at time t0 to t1, monitor data of the physical core P_x, which is dispatched to the logical core A0 which is an object event of the monitor context A, is recorded.

At time t1 to t2, the monitor operation condition for the monitor context A is satisfied and the monitor operation condition for the monitor context B is also satisfied. However, since priority of the monitor context A is higher than that of the monitor context B, at time t1 to t2, the monitor data of the physical core P_x, which is dispatched to the logical core A0 which is the object event of the monitor context A, is recorded continuously.

At time t2 to t3, the monitor operation condition for the monitor context A is dissatisfied and the monitor operation condition for the monitor context B is satisfied. Therefore, at time t2 to t3, monitor data of the physical core P_y, which is dispatched to the logical core B0 which is an object event of the monitor context B, is recorded.

At time t3 to t4, the monitor operation condition for the monitor context A is dissatisfied and the monitor operation condition for the monitor context B is also dissatisfied. Therefore, at time t3 to t4, recording of the monitor data is invalid, i.e., disabled and is not performed.

At time t4 to t5, the monitor operation condition for the monitor context A is satisfied and the monitor operation condition for the monitor context B is also satisfied. At time t4 to t5, as at time t1 to t2, priority of the monitor context A is higher than that of the monitor context B. Therefore, the monitor data of the physical core P_y, which is dispatched to the logical core A0 which is the object event of the monitor context A, is recorded.

At time t5 to t6, the monitor operation condition of the monitor context A is dissatisfied and the monitor operation condition of the monitor context B is satisfied. Therefore, at time t5 to t6, the monitor data of the physical core P_x, which is dispatched to the logical core B0 which is the object event of the monitor context B, is recorded.

FIGS. 10 and 11 are diagrams showing what the buffers for monitor data storage of the respective monitor contexts are finally like as a result of the example of execution shown in FIG. 8. FIG. 10 is a diagram showing an example of content of the buffer for the monitor context A. FIG. 11 is a diagram showing an example of content of the buffer for the monitor context B. As shown in FIG. 10, in the buffer for the monitor context A, only the Start flag 41 and the Stop flag 43 are present. The monitor data 42 is always recorded when the monitor operation condition is satisfied. On the other hand, in the buffer for the context B, as shown in FIG. 11, the Fake_Start flag 44 and the Fake_Stop flag 45 are present. The monitor data 42 cannot be acquired in a period of the Fake_Start flag 44 and the Fake Stop flag 45. However, if the timing data 40 is used, it is possible to automatically or manually calculate coverage of acquired monitor data and use the coverage for judging reliability of discontinuous data.

As described above, according to the present embodiment, in order to realize hardware monitor function management effective in the multi-core processor, conflict among the plural hardware monitor contexts is arbitrated. Therefore, the monitor contexts have priority information as an element. As a result, it is possible to continuously acquire important monitor data, which is data that the user desires to acquire.

Moreover, concerning a monitor context with low priority, monitor data becomes discontinuous because of time division use of the hardware monitor function. To cope with this problem, in the present embodiment, timing data at the time of switching of a monitor context is recorded to make it possible to judge reliability of the discontinuous data. Therefore, it is possible to support analysis of the discontinuous data.

Moreover, in the present embodiment, in order to meet monitor data acquisition requests in various units or ranges, the monitor contexts have monitor operation condition information as an element thereof.

Therefore, according to the present embodiment, it is possible to solve conflict with respect to the hardware monitor function, support analysis of discontinuous data, and cope with data acquisition requests in various units and ranges.

Modifications of the embodiment described above are explained.

In the embodiment described above, the hypervisor OS 6, specifically, the logical core scheduler 6a performs setting of monitor contexts, operation of the hardware monitor function unit, and the like. However, even when logical partitions and logical cores are not provided, it is possible to realize the hardware monitor function described above.

Specifically, in the embodiment described above, the hypervisor OS 6 is used and, when the hypervisor OS 6 manages the hardware monitor function of the processor 1, concerning setting of the hardware monitor function, logical values are allowed to be set in the respective logical partitions and the logical core scheduler 6a of the hypervisor OS 6 converts the logical values into physical values corresponding thereto during execution to thereby cope with virtualization of hardware. In a first modification of the embodiment, a hypervisor OS is not present, i.e., an OS as a hardware monitor managing apparatus manages hardware monitor contexts of respective processes.

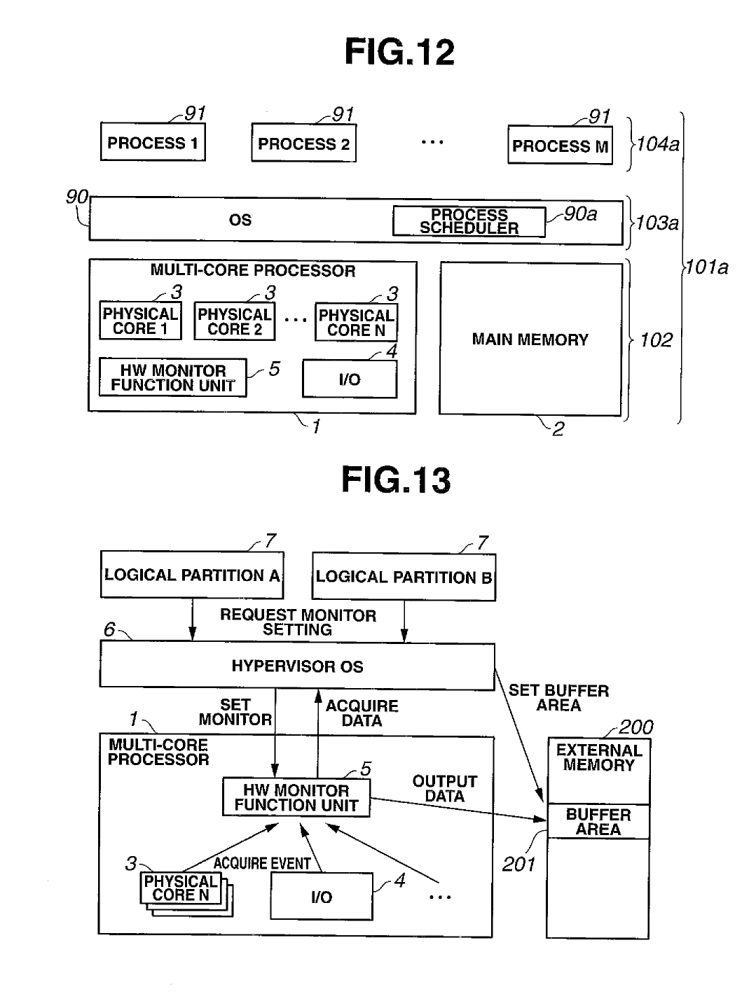

FIG. 12 is a block diagram showing the structure of a system according to a first modification of the present embodiment. An OS 90 is present above the multi-core processor 1. Plural (M; M is an integer equal to or larger than 2) processes 91 operate on the OS 90. The OS 90 in an intermediate layer 103a has a process scheduler 90a that performs context switch processing for the plural process 91 in a higher layer 104a. Therefore, hardware monitor contexts corresponding to the respective processes 91 are set and the process scheduler 90a of the OS 90 switches the monitor contexts. The process scheduler 90a as a scheduler unit configures the hardware monitor managing unit that performs setting of monitor contexts, operation of the hardware monitor function unit, and the like according to the embodiment described above.

In the first modification, as the structure of a monitor context, it is possible to apply the structure same as that shown in FIG. 3. The first modification is different from the embodiment described above in the monitor operation condition information 32. A process ID is designated instead of a logical core ID. Processing by the process scheduler 90a of the OS 90 is the same as the processing by the logical core scheduler shown in FIG. 7 if the logical cores are regarded as processes. In FIG. 8, operation states are the same if the respective logical cores are regarded as processes.

A second modification of the embodiment is explained. FIG. 13 is a diagram for explaining the second modification.

In the hardware monitor function according to the embodiment described above, monitor data is acquired by access to the registers exclusively used for the data. However, if there is a hardware monitor function including a function of automatically outputting monitor data to an external memory of a processor at predetermined timing (an automatic external output function), a more excellent performance measurement environment can be realized. For example, overhead of data storage processing is eliminated, time-series monitor data can be acquired, and performance measurement in a long time can be performed by using a large-capacity external memory. Therefore, in the second modification, such an automatic external output function is provided in a hardware monitor function unit.

FIG. 13 is a diagram for explaining a relation between a hardware monitor function unit having the automatic external output function and a host OS. FIG. 13 is different from FIG. 2 in that the hardware monitor function unit 5 automatically outputs monitor data to a predetermined buffer area 201 on an external memory 200. A position of the buffer area 201 is set in the hypervisor OS 6 in advance. The predetermined buffer area 201 is set as a storage area in an external memory provided on the outside of one processor 1 including plural physical cores.

In monitor contexts, information concerning an address, a size, and a write pointer of the buffer area 201 as an output destination of monitor data is set for each of the monitor contexts as one piece of the context management information 31 shown in FIG. 3.

In processing of the logical core scheduler shown in FIG. 7, switching of buffer areas is performed simultaneously with the switching of the monitor contexts (step S8). As a result, when a monitor operation is started (step S17), monitor data is automatically outputted to a new buffer area. Therefore, when the monitor operation is finished in steps S6 and S12, unlike the embodiment, it is unnecessary to acquire and store monitor data. Timing data is recorded in the same manner as in the embodiment.

A third modification of the embodiment is explained. As the third modification, a hypervisor OS or an OS may permit use of the hardware monitor function only for a specific logical partition. In other words, a hypervisor OS or an OS including a scheduler unit may be allowed to limit setting of the hardware monitor function for each of the plural processes and the like.

According to the embodiment described above, it is possible to set validity and invalidity of monitor contexts according to the context management information of the monitor contexts 30. If the monitor contexts are set valid for all the logical partitions, a request for setting of the hardware monitor function for all the logical partitions is permitted. However, from the viewpoint of security and content protection, a request for limiting logical partitions for which the hardware monitor function can be used is also conceivable. For that purpose, the hypervisor OS or the OS may have a limitation function for permitting use of the hardware monitor function only for the specific logical partition and rejecting all requests from the other logical partitions.

Therefore, concerning the logical partition permitted to use the hardware monitor function by the hypervisor OS or the like, according to setting of the monitor operation conditions, as described above, it is possible to acquire monitor data in logical core units belonging to a single logical partition, acquire monitor data concerning the entire single logical partition, or acquire monitor data concerning the entire system. As a result, it is possible to realize functions same as those in the embodiment described above.

A fourth modification of the embodiment is explained. As the fourth modification, when the multi-core processor includes plural hardware monitor function units, the plural hardware monitor function units may be allocated on the basis of the priority information of the monitor contexts described above. In other words, in the processor including the plural hardware monitor function units, the hardware monitor function units may be allocated in order from a monitor context with highest priority.

Specifically, when the hardware monitor function is executed in one or more hardware monitor function units, the logical core scheduler 6a or the like as the hardware monitor managing unit allocates one or more monitor contexts, for which the hardware monitor function is set, in order of priority of the priority information.

In that case, if the number of hardware monitor function units is smaller than the number of physical cores and the respective hardware monitor function units have identical specification, even if conflict with respect to the hardware monitor function occurs among processes operating on the respective logical core, it is possible to cope with such conflict by allocating the hardware monitor function units in order of priority using the priority information of the monitor contexts.

A program for executing the operations explained above is provided as a computer program product in which the entire program or a part of the program is recorded or stored in a portable medium such as a flexible disk or a CD-ROM or a storage medium such as a hard disk. Various commands corresponding to the operations described above in the program are read by a computer and all or a part of the operations are executed. Alternatively, it is also possible to circulate or provide the entire program or a part of the program as a program product through a communication network. The user can easily realize the hardware monitor managing apparatus according to the present invention by downloading the program through a communication network and installing the program in a computer or by installing the program in the computer from the storage medium.

As described above, according to the embodiment, it is possible to provide a hardware monitor managing apparatus and a method of executing a hardware monitor function that can solve conflict among plural monitor contexts and support accurate performance analysis when operation states of plural physical processors that execute plural processes in parallel are monitored.

The present invention is not limited to the embodiment described above. Various modifications, alterations, and the like are possible without departing from the spirit of the present invention.

What is claimed is:

1. A hardware monitor managing apparatus comprising:
a monitor context table in which plural monitor contexts each including monitor operation conditions and information concerning priority are set in order to set a hardware monitor function for monitoring operation states of plural physical processors that execute plural processes in parallel; and
a hardware-monitor managing unit that causes the hardware monitor function to execute on a monitor context for which the hardware monitor function determined on the basis of the priority is set, among one or more monitor contexts satisfying the monitor operation conditions, for acquiring monitor data and outputting the monitor data together with first time data indicating time when the monitor operation condition is satisfied, and outputs second time data, which indicates time when the monitor operation condition is satisfied, on a monitor context for which the hardware monitor function determined on the basis of the priority is not set, among the one or more monitor contexts satisfying the monitor operation conditions.

2. The hardware monitor managing apparatus according to claim 1, wherein the monitor operation conditions include conditions concerning execution states of the plural processes represented by using a logical arithmetic expression.

3. The hardware monitor managing apparatus according to claim 1, further comprising a scheduler unit that allocates plural logical processors that execute the plural processes in parallel to the plural physical processors, wherein
the scheduler unit has the monitor context table and the hardware monitor managing unit.

4. The hardware monitor managing apparatus according to claim 3, wherein the monitor operation conditions include conditions concerning execution states of the plural logical processors represented by using a logical arithmetic expression.

5. The hardware monitor managing apparatus according to claim 3, wherein the scheduler unit is a logical core scheduler of a hypervisor operating system that associates plural logical core processors that execute the plural processes and the plural physical processors.

6. The hardware monitor managing apparatus according to claim 2, wherein the logical arithmetic expression is an expression employing at least one of a logical sum and a logical product.

7. The hardware monitor managing apparatus according to claim 4, wherein the logical arithmetic expression is an expression employing at least one of a logical sum and a logical product.

8. The hardware monitor managing apparatus according to claim 1, wherein the hardware monitor managing unit outputs the acquired monitor data to a predetermined buffer area.

9. The hardware monitor managing apparatus according to claim 8, wherein the predetermined buffer area is a storage area in an external memory provided on an outside of one multi-core processor including the plural physical processors.

10. The hardware monitor managing apparatus according to claim 9, wherein information concerning the storage area in the external memory is set in each of the plural monitor contexts.

11. The hardware monitor managing apparatus according to claim 3, wherein the scheduler unit can limit the hardware monitor setting with respect to each of the plural processes.

12. The hardware monitor managing apparatus according to claim 1, wherein, when the hardware monitor function is executed in plural hardware monitor function units, the hardware monitor managing unit determines by allocating, in order of the priority, monitor contexts for setting the hardware monitor function thereto.

13. A method of executing a hardware monitor function comprising:
providing a monitor context table in which plural monitor contexts each including monitor operation conditions and information concerning priority are set in order to set a hardware monitor function for monitoring operation states of plural physical processors that execute plural processes in parallel;
causing the hardware monitor function to execute on a monitor context for which the hardware monitor function determined on the basis of the priority is set, among one or more monitor contexts satisfying the monitor operation conditions, for acquiring monitor data and outputting the monitor data together with first time data indicating time when the monitor operation condition is satisfied; and
outputting second time data, which indicates time when the monitor operation condition is satisfied, on a monitor context for which the hardware monitor function determined on the basis of the priority is not set, among the one or more monitor contexts satisfying the monitor operation conditions.

14. The method of executing a hardware monitor function according to claim 13, wherein the monitor operation conditions include conditions concerning execution states of the plural processes represented by using a logical arithmetic expression.

15. The method of executing a hardware monitor function according to claim 13, wherein a scheduler unit that allocates plural logical processors that execute the plural processes in parallel to the plural physical processors has the monitor context table, acquires and outputs the monitor data, and outputs the first and second time data.

16. The method of executing a hardware monitor function according to claim 15, wherein the scheduler unit is a logical core scheduler of a hypervisor operating system that associates plural logical core processors that execute the plural processes and the plural physical processors.

17. The method of executing a hardware monitor function according to claim 13, wherein the acquired monitor data is outputted to a storage area in an external memory provided on an outside of one multi-core processor including the plural physical processors.

18. The method of executing a hardware monitor function according to claim 13, wherein the hardware monitor function setting can be limited with respect to each of the plural processes.

19. The method of executing a hardware monitor function according to claim 13, wherein, when the hardware monitor function is executed in plural hardware monitor function units, the hardware monitor managing unit determines by allocating, in order of the priority, monitor contexts for setting the hardware monitor function thereto.

20. A storage medium having stored therein a program for causing a computer to execute a hardware monitor function, the program comprising:
first instructions for scanning a monitor context table in which plural monitor contexts each including monitor operation conditions and information concerning priority are set in order to set a hardware monitor function for monitoring operation states of plural physical processors that execute plural processes in parallel;
second instructions for causing the hardware monitor function to execute on a monitor context for which the hardware monitor function determined on the basis of the priority is set, among one or more monitor contexts satisfying the monitor operation conditions, for acquiring monitor data and outputting the monitor data together with first time data indicating time when the monitor operation condition is satisfied; and
third instructions for outputting second time data, which indicates time when the monitor operation condition is satisfied, on a monitor context for which the hardware monitor function determined on the basis of the priority is not set, among the one or more monitor contexts satisfying the monitor operation conditions.
